(19) United States
(12) Patent Application Publication
(10) Pub. No.: US 2007/0058537 A1
(43) Pub. Date: Mar. 15, 2007

(54) Handling of early media ii

(76) Inventor: Thomas Belling, Munich (DE)

Correspondence Address: STAAS & HALSEY LLP, SUITE 700, 1201 NEW YORK AVENUE, N.W., WASHINGTON, DC, 20005, US

(21) Appl. No.: 10/576,189

(22) PCT Filed: Sep. 24, 2004
(86) PCT No.: PCT/EP04/52311

§ 371 Date: Apr. 17, 2006

(30) Foreign Application Priority Data
Oct. 16, 2003 (DE) 103 48 207.5

(51) Int. Cl. H04L 12/26; H04L 12/56

(52) U.S. Cl. 370/230; 370/395.21

(57) ABSTRACT

To efficiently select early media data, useful data is selected that is transmitted during the initiation of a call between a calling subscriber and at least one called subscriber via at least one telecommunications network. Recipient-address data for the called subscriber and transmission-address data for the calling subscriber is extracted from a response message of a called subscriber that is received by the calling subscriber and the called subscriber transmission-address data is used by the calling subscriber to select the useful data of a called subscriber, which has been received by the calling subscriber.

### CROSS REFERENCE TO RELATED APPLICATIONS

This application is based on and hereby claims priority to German Application No. 10348207.5 filed on Oct. 16, 2003, the contents of which are hereby incorporated by reference.

### BACKGROUND OF THE INVENTION

1. Field of the Invention

The invention relates to a method for selecting “early media” user data transmitted from at least one called subscriber B to a calling subscriber A via at least one telecommunication network during initiation of a call.

2. Description of the Related Art

The Session Initiation Protocol (SIP) is a signaling protocol that can be used for call control, for example, of telephone conversations. SIP is standardized by the IETF in RFC 3261 and in an older version in RFC 2543. To describe the switched communication connection, SIP uses the Session Description Protocol (SDP), IETF RFC 2327, in a manner described in IETF RFC 3264. SIP, together with the negotiated full user data connections (e.g. speech connections), is usually transmitted using the Internet protocol. SIP is used in the above-described manner in, for example, the Internet Multimedia Subsystem (IMS) of a mobile radio communication network standardized by 3GPP or 3GPP2.

During initiation of a call from the SIP terminal of a caller A to a called user B, the SIP signaling can be redirected by switching nodes or “proxies”. The proxies are permitted to redirect an incoming message which presents a request by the user A for a connection to B (an INVITE request) to a plurality of other proxies or SIP terminals simultaneously or sequentially—for example, in order to search for the user B. Because the last-mentioned proxies can branch the message when redirecting it, a tree-like branching of the message can occur. This branched redirection of messages is referred to in SIP as “forking”.

When the INVITE message reaches a terminal of user B, this terminal can respond with what is called a “1xx provisional response” which can serve, for example, to negotiate the media (e.g. speech, video) used for the communication connection and their coding, or to indicate that the user B is being alerted (for example, by the ringing of a SIP telephone). In the event of forking, it can happen that a plurality of terminals send such provisional responses—for example, if a plurality of SIP telephones ring simultaneously. To conclude the initiation of the communication relationship between a terminal of caller A and a terminal of the called party B, the latter terminal responds with what is called a “2xx final response”, for example, when user B has taken the SIP telephone off the hook. A plurality of terminals of B can send such final responses, for example, if a plurality of ringing SIP telephones are taken off the hook. Accordingly, it can happen that the terminal of A receives provisional responses and/or final responses from a plurality of terminals of B. Each terminal of B provides all the messages it sends as responses to A with the same unique identification. If SIP response messages with a new identification reach the terminal of A, the terminal of A learns therefrom that it is communicating with a new terminal point. In this case the SIP refers to a “dialogue” existing between the terminal of A and the responding terminal of B. Before A (and/or B, if applicable) has received a final response for a dialogue, this is referred to as an “early dialogue”, the subsequent state as an “established dialogue”.

It can happen that before the end of initiation of the communication relationship, the terminals of A and B exchange media (user data) which is referred to as “early media”. For example, as in a conventional telephone network, ring tones and announcements may be transmitted, preferably in the direction from B to A. For a telephone network with SIP signaling, support by an “early media” transmission is especially important if the network is connected to a conventional telephone network.

If a plurality of dialogues are established in (/with) terminal A during initiation of the communication relationship from A to B as a result of forking, A may also receive media (user data), in particular early media, from different terminals B, B′. The terminal of A must represent the media in a suitable fashion. For example, it is possible that different incoming video streams are displayed in separate windows on a display screen. Frequently, however, it is appropriate to select only one incoming media stream and to reject the remaining media streams—for example, because the display screen in a mobile terminal is too small to show a plurality of windows, or because the superposing of different ring tones or announcements would make the content unintelligible.

Information on the corresponding SIP dialogues might be criteria permitting the selection of a suitable media stream (user data stream) for representation:
If an early dialogue becomes an established dialogue through receipt of the first SIP final response, it is appropriate to select the corresponding media stream.
It may be appropriate to select the early media that corresponds to the early dialogue last established. This is especially the case if the proxies initiate forking in a sequential manner. If the terminal sends a negative response, or if after a given time the communication relationship with it has not been established, for example, because no user has gone “off-hook”, a proxy redirects the INVITE request to a different terminal. The IETF specifies methods which will enable terminal A to request a proxy to search only sequentially (draft-ieff-sip-callerprefs).
Terminal A can terminate dialogues using SIP signaling—for example, because it is able to support only a limited number of dialogues. The corresponding media can, however, continue to be received for a certain time because of the delay times of signaling and media. It is desirable to suppress the media during this transition time.

The information contained in SIP and SDP does not always unambiguously allow a SIP dialogue to be correlated with the corresponding media stream. In particular, the terminal of caller A selects an IP address and port, for example, a UDP port (see IETF RFC 768) to receive the media streams before it sends the INVITE request containing this information. All incoming media are therefore received at the same IP address and the same port. They can be distinguished by using the parameter “source IP address” in the IP header and “source port” in the UDP header of the packets received, i.e. the IP address and the port from which the packets were sent. However, according to RFC 3264, no information on this source IP address and source port is contained in SIP/SDP, but only on the destination IP address and the destination port, i.e. the IP address and port to which the packets were sent.

When SIP forking was designed, the interaction with early media was at first not considered, since early media occur in a SIP network only in special cases, for example, in conjunction with a conventional telephone network.

The handling of early media (user data) in the case of forking is currently being discussed in the IETF SIPPING Working Group. The “draft-camarillo-sipping-early-media” draft proposes that separate communication connections for early media user data be negotiated using SIP, terminal B acting as caller in the communication connections for early media when it receives a call from A for the actual user connection and initially enters into an early dialogue regarding this call for the user connection with A. However, this has the disadvantage that considerably more SIP messages must be exchanged, leading to delay in initiating the call and higher resource demand, especially when transmitting via an air interface with narrow bandwidth. In addition, it might possibly be necessary to reserve separate transmission resources for early media and for the actual user connection.

In the “draft-ietf-mmusic-sdp-srcfilter” the IETF MMUSIC Working Group proposes to introduce into SDP a parameter which allows expression of the source IP address and the source UDP port from which a recipient wishes to receive packets. This information is useful in configuring interposed firewalls. However, this parameter is unsuitable for correlating SIP dialogues and media streams because it presupposes that the recipient already knows the source IP address and the source UDP port. Moreover, the use of this parameter in H.248 signaling has not so far been described.

### SUMMARY OF THE INVENTION

It is an object of the present invention to make it possible to select (early media) user data as efficiently as possible during SIP call initiation signaling.

The transmission according to the invention of called subscriber transmission address data (IP b, port b for subscriber B or IP b′, port b′ for subscriber B′), in addition to the called subscriber reception address data (IP B, port B for subscriber B, etc.) known to be transmitted in any case, in a response message (provisional response and/or final response of a destination to a calling subscriber) enables the calling subscriber A to use this received destination transmission address data to select efficiently from early media user data of different called subscribers (B,B′) received by it.

The fact that, according to the invention, called subscriber transmission address data (IP b, port b) is derived from a response message (provisional response 9, 10; 11, 12; final response 17) of a called subscriber (B; B′) received by the calling subscriber (A) and containing called subscriber transmission address data (IP b, port b) in addition to called subscriber reception address data (IP B, port B) can mean, for example, that this called subscriber transmission address data (IP b, port b) can be noted by the calling subscriber (A) or (temporarily) stored for later selection.

### BRIEF DESCRIPTION OF THE DRAWINGS

These and other objects and advantages of the present invention will become more apparent and more readily appreciated from the following description of an embodiment, taken in conjunction with the accompanying drawings of which:

FIG. 1 is a signal flow diagram of the signaling during initiation of a call and transmission of early media user data.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

Cellular mobile radio communication networks (such as GSM, 3G CDMA2000, TDSCDMA, etc.) and fixed networks, and associated terminals and signaling procedures (SIP, SDP), are known per se to those skilled in the art (see, for example, specifications in www.3gpp.org).

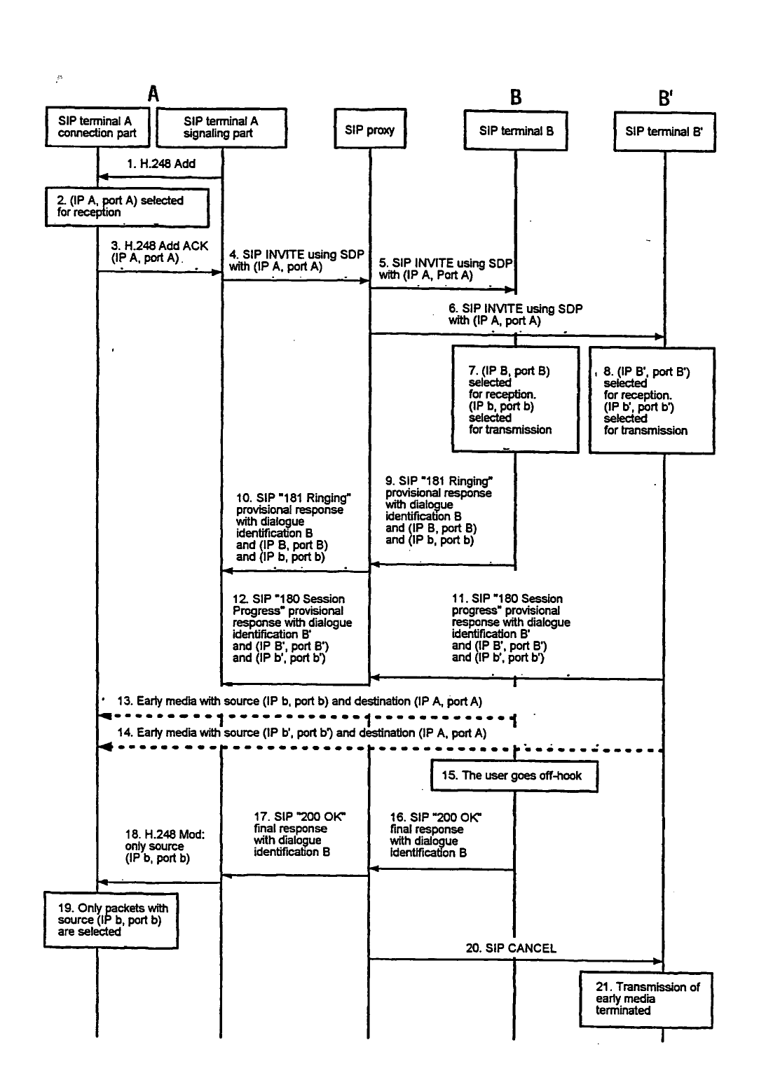

FIG. 1 shows a calling subscriber A, including a SIP terminal A connection part and a SIP terminal A signaling part, which communicates via a mobile radio communication network (represented here only by a SIP proxy necessary for an understanding of the invention) with a called subscriber (=B) including a SIP terminal B, and a called subscriber (=B′) including a SIP terminal B′, using a SIP protocol to initiate a telecommunication connection (e.g. speech connection, etc.). The SIP terminal A connection part may be, for example, a so-called “IM-MGW” and the SIP terminal A signaling part may be a so-called “MGCF”, the SIP proxy may be a so-called “S-CSCF” and the SIP terminals B and B′ may be so-called “UE”s. For simplicity a number of SIP messages, for example, “100 Trying”, PRACK and 200 OK (PRACK) have been omitted.

In the example illustrated, following a message 1 from the SIP terminal A signaling part to the SIP terminal A connection part, initiation of a telecommunication connection (for example, for a speech connection or other user data connection) is attempted, the messages 3-7, 9, 10, 13 being exchanged between the calling subscriber A and the called subscriber B (via a signaling network/via the SIP proxy) before the user B goes off-hook (step 15) at the called subscriber terminal B.

The SIP terminal A connection part selects the address to be used by the SIP terminal A for future reception (IP address of A (IP A) and port number of A (port A)), transfers these in step 3 to the SIP A signaling part which, in step 4, sends a SIP INVITE message specifying the terminal A reception address (IP A, port A) to a SIP proxy of a telecommunication network (for example, of a cellular mobile radiocommunication network) which applies SIP forking and, in steps 5 and 6, transmits this SIP INVITE message to the called subscriber B terminal (SIP terminal B) and the called subscriber B′ terminal (SIP terminal B′).

Then, in step 7, the SIP terminal B selects its called subscriber reception address (IP B, port B) and transmission address (IP b, port b). In step 8 SIP terminal B′ selects its called subscriber reception address (IP B′ and port B′) for reception, and its called subscriber transmission address (IP b′ and port b′) for transmission.

In step 9 the called subscriber reception address (IP B, port B) selected in called subscriber B and, according to an aspect of the invention, the called subscriber transmission address (IP b, port b) together with a unique identification of the dialogue B, are transmitted in a SIP 181 Ringing provisional response message to a SIP proxy of a telecommunication network, which transmits them to the calling subscriber (A) in step 10. In addition, in step 11, a SIP 180 Session Progress provisional response message with the further called subscriber reception address (IP B′, port B′) and, according to an aspect of the invention, the called subscriber transmission address (IP b′, port b′) and the dialogue identification B′, are transmitted onwards by the further SIP terminal B′ to the SIP proxy and, (in step 12) to SIP terminal A (the calling subscriber A).

To transmit the called subscriber transmission addresses (IP b, port b) and (IP b′, port b′) in messages 9 to 12 according to an aspect of the invention, a newly-introduced SDP parameter may, for example, be used.

Through the receipt of messages 9 and 11 with different dialogue identifications B and B′, the SIP terminal A connection piece knows that it is signaling with two terminals B and B′, and that at this time both terminals are possibly transmitting data (=early media data=media stream data) to (IPA, port A), as in steps 13 and 14, from the called subscriber (=SIP terminal B or B′) to the terminal of the calling subscriber A. At this happens the SIP terminal B (or the further destination and SIP terminal B′) specifies a called subscriber transmission address (IP b, port b or IP b′, port b′) indicating where the data originates, to enable the calling subscriber A to determine its origin. In addition, the early media data transmitted in step 13 and 14 also contains a destination address of the calling subscriber (A) which is used for IP routing. Early media data may contain, for example, ring tones, announcements, etc.

If (through forking) calls are redirected to a plurality of telecommunication network switching devices (proxies) and/or SIP terminals (such as B, B′) simultaneously or sequentially, and are possibly redirected to further terminals by addressed SIP terminals B, B′ and/or proxies, provisional responses and possibly early-media media stream data from many terminals may arrive at terminal A of the calling subscriber, selection among which is optimized simply and efficiently according to an aspect of the invention.

This is accomplished in that (contrary to the procedure according to the standardization documents mentioned in the introduction) a called subscriber B transmission address (IP b, port b) is transmitted together with the called subscriber reception address (IP B, port B) (transmitted in a response) in a response message (provisional response or final response) of a called subscriber B, and the called subscriber B transmission address (IP b, port b) is used for the selection (further processing or storage or rejection, etc.).

Rejection may take place, for example, if, after a “200-OK” final response message has been forwarded by the called subscriber terminal B to the calling subscriber terminal (A) in steps 16, 17, and the successful ending of the call initiation is signaled, so that an established dialogue between terminal A and terminal B is then established, whereupon, for example, early media data streams which do not correspond to the established dialogue established with the message 16/17 (and which therefore contain a different subscriber transmission address) can be rejected (e.g. suppressed or ignored) by the calling subscriber A. According to the invention the suppression is effected in that the media stream data with transmission addresses other than (IP b, port b) is ignored. The SIP terminal A signaling part informs the SIP terminal A connection part in message 17 that only media stream data with the transmission address (IP b, port b) must be accepted. For this purpose a new parameter expressing one or more transmission addresses the packets of which must be accepted is introduced, for example, in message 17. The same new SDP parameter as is used in messages 9 to 12, which is transported in SDP within a MOD message of the H.248 protocol, may, for example, be used. Alternatively, the SDP parameter proposed by the IETF MMUSIC Working Group in “draft-ietf-mmusic-sdp-srcfilter” may be used.

In this way a so-called “clipping” can be avoided, i.e. a non-existent user connection after initiation of the connection in the signaling has been completed on the basis of a final response of a SIP terminal B, once the user has gone off-hook. The non-existent user connection is produced by further processing of early media data streams which are no longer relevant. Otherwise, it would be only upon receipt of a SIP CANCEL message (step 20) from the SDP proxy to the further SIP terminal (B′), for example, that (only) this SIP terminal B′ would stop transmitting early media data streams, and the clipping could continue to exist in a transition period for as long as terminal A was still receiving this early media data.

For example, after receiving a message 9, 10 from B with called subscriber (B) transmission address data (IP b, port b) (contained in the message), the calling terminal A in the example in FIG. 1 can either select for further use user data (early media data) received later in a message 13 on the basis of called subscriber transmission address data (IP b, port b) contained in message 13, or reject, i.e. delete or ignore, user data containing called subscriber transmission address data which has not been forwarded in an earlier provisional response or final response message (9, 10; 11, 12).

The information contained in SDP on the source IP address and the source port is used by the terminal of caller A in the manner according to the invention to select packets from suitable media streams for representation.

In a preferred embodiment a new parameter which is used in the provisional responses and/or final responses sent by a terminal of B to the SIP terminal of A is introduced in SDP. This parameter enables the terminal(s) of caller B to express which IP address and which port is used in each case by these terminals to send IP packets. (Up to now, SDP from B to A contains only information on the IP address and port at which B wishes to receive IP packets.) Because the provisional responses and/or final responses contain a unique identification of the SIP dialogue, and the IP address used by a terminal B for transmission, and the port used for transmission, i.e. the source IP address and the source port, in packets of the corresponding media stream received by A, it is possible for A to carry out an unambiguous correlation (allocation) between a SIP dialogue and a received media stream.

The terminal of A uses this correlation to select suitable media streams, e.g., according to one or more of the following:
When the first early dialogue becomes an established dialogue upon receipt of a SIP final response, the terminal of A selects the appropriate media stream.
The terminal of A selects the early media corresponding to the early dialogue last established—possibly for only as long as no established dialogue yet exists.
The terminal of A suppresses early-media media streams (user data) as soon as it sends SIP signaling messages to end the corresponding dialogues.

The SIP terminal of A may be divided into a signaling device and a device for handling user connections, which devices communicate with one another, for example, by using the protocols H.248 or RFC 3525 jointly specified by the ITU-T and IETF, or by using the MGCP protocol IETF RFC 2705. For example, the SIP terminal of A may consist of a 3GPP-standardized MGCF and IM-MGW, or of a MRFC and MRFP, also standardized by 3GPP, see 3GPP TS 23.002. SDP is also transported by H.248 or MEGACO. Here, too, the new SDP parameter according to the invention is used to specify the source IP address and the source UPD port with which received user connection packets are to be accepted. If this parameter is used, user connection packets with other source IP addresses and other source port are to be rejected.

Other examples of terminals which are not divided are mobile 3GPP or 3GPP2 terminals known as UEs.

For simplicity, various SIP messages, for example, 100 Trying, PRACK and OK(PRACK) are not shown in FIG. 1.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV 69 USPQ2d 1865 (Fed. Cir. 2004).

1-19. (canceled)

20. A method for selecting user data transmitted from at least one called subscriber to a calling subscriber via at least one telecommunication network during initiation of a call, comprising:
deriving called subscriber transmission address data from a response message of a called subscriber received by the calling subscriber and containing the called subscriber transmission address data in addition to called subscriber reception address data; and
using the called subscriber transmission address data for selection by the calling subscriber of user data subsequently received by the calling subscriber from the called subscriber.

21. A method according to claim 20, wherein the calling subscriber receives other user data from at least one other called subscriber.

22. A method according to claim 21, wherein the telecommunication network includes a cellular mobile radio communication network.

23. A method according to claim 22, wherein the called subscriber transmission address data contains an internet protocol address and a port address.

24. A method according to claim 23, wherein said deriving derives the called subscriber transmission address data from at least one of a provisional session initiation protocol message and a final session description protocol message sent by the called subscriber to the calling subscriber.

25. A method according to claim 24,
further comprising receiving a session initiation protocol final response message with the called subscriber transmission address data contained therein, and
wherein said using includes the calling subscriber selecting first incoming user data in a selection using the called subscriber transmission address represented by the called subscriber transmission address data, and rejecting second incoming user data having other called subscriber transmission addresses.

26. A method according to claim 25, further comprising transmitting the called subscriber transmission address data in the response message using a new session description protocol parameter.

27. A method according to claim 26, further comprising transmitting at least one transmission address, between a session initiation protocol terminal signaling part and a session initiation protocol terminal connection part of the calling subscriber, indicating from which transmission addresses received user data packets are to be accepted exclusively.

28. A method according to claim 27, further comprising expressing a source internet protocol address and a source user datagram protocol port using a session description protocol parameter defined by the IETF MMUSIC Working Group in the “draft-ieff-mmusic-sdp-srcfilter”.

29. A method according to claim 27, wherein said transmitting of the at least one transmission address uses the new session description protocol parameter.

30. A method according to claim 29, wherein one of a H.248 protocol and a media gateway control protocol is used for signaling between the session initiation protocol terminal signaling part and the session initiation protocol terminal connection part.

31. A method according to claim 30, wherein said selecting includes selecting the received user data by the calling subscriber using the called subscriber transmission address data contained in a provisional response message received most recently, for as long as the calling subscriber does not receive a final response message.

32. A method according to claim 31, further comprising rejecting by the calling subscriber all user data as soon as the signaling message “SIP CANCEL request” is sent ending call initiation signaling.

33. A method according to claim 32, further comprising specifying at least one of called subscriber transmission address data and called subscriber reception address data in a session description protocol parameter in the response message received by the calling subscriber.

34. A method according to claim 33, wherein the called subscriber reception address data and the called subscriber transmission address data of the called subscriber may be different.

35. A method according to claim 34, wherein the user data is early media data.

36. An apparatus for selecting user data transmitted from at least one called subscriber to a calling subscriber via at least one telecommunication network during initiation of a call, comprising:
derivation means for deriving called subscriber transmission address data from a response message of a called subscriber received by the calling subscriber and containing the called subscriber transmission address data in addition to called subscriber reception address data; and
selection means for using the called subscriber transmission address data for selection by the calling subscriber of user data subsequently received by the calling subscriber from the called subscriber.

37. An apparatus according to claim 36, wherein said selection means includes either a MGCF and a IN-MGW or a MRFC and a MPFP.

38. An apparatus according to claim 37, further comprising transmission means for transmitting early media data via IP packets specifying at least one called subscriber address.
